(19) United States
(12) Patent Application Publication
(10) Pub. No.: US 2002/0162283 A1
(43) Pub. Date: Nov. 7, 2002

(54) Jacking & tipping restraint apparatus and design of communications towers to enable entire tower erection at ground level

(76) Inventor: Jack Myron Benson, Silver Spring, MD (US)

Correspondence Address: JACK M. BENSON, 9338 HARVEY ROAD, SILVER SPRING, MD, 20910, US

(21) Appl. No.: 09/845,499

(22) Filed: May 1, 2001

(51) Int. Cl. E04H 12/34; B66C 23/34

(52) U.S. Cl. 52/123.1

(57) ABSTRACT

An apparatus consisting of a self standing communications tower or a guy wire supported communications tower with such structural design as to allow raising the tower from ground level with an upper section raised up and a lower section inserted below. The apparatus structural design allows for a tie down to prevent toppling during the erection sequence.

The erection apparatus enables raising the towers from the ground level by assembling and raising each section followed by assembling and raising the adjacent lower section until the tower is completely assembled.

A tie down apparatus to secure the tower from toppling over during erection.

The apparatus provides for more efficient fabrication and erection while increasing personnel safety.

### FIELD OF THE INVENTION

The present invention relates to the design of two (2) types of communications towers a self standing tower and a guy cable supported tower. The structural design allows jacking the towers from ground level with each assembled section raised up and a lower section inserted below. The structural design allows for tipping restraints to prevent toppling during the erection sequence.

This invention includes the design of erection apparatus that enables jacking the towers from the ground level by fabricating the towers in such a manner that they can be erected by assembling and raising each section followed by assembling and raising the adjacent lower section until the tower is completely assembled.

This invention includes the design of a tipping restraint apparatus to secure the tower from toppling over during erection.

More particularly, the invention details a structural design that provides for more efficient fabrication and erection while increasing personnel safety.

### DESCRIPTION OF RELATED ART

The skyrocketing use of wireless telephones has accordingly increased the number of installations of monopole, stand alone, and guy cable supported communication towers. The traditional method of installation is inefficient and endangers the lives of the erectors.

The current methods of tower erection are disadvantageous because they require hoisting each piece of the tower up the tower for its individual assembly. Conventional erection typically requires several weeks to completely assemble a tower. It requires that two men climb the tower as the erection progresses. Thus they will be working hundreds of feet above the ground where working conditions can be very hazardous.

The above mentioned towers have achieved a certain degree of commercial utility, however, there are deficiencies in these prior apparatuses. For example, these towers are not designed for efficient shop fabrication nor field assembly. It is disadvantageous wherein the higher towers are above the reach of commercial cranes and must be inefficiently erected by winching each tower component up hundreds of feet to its assembly point. Also the conventional erection of towers places the erectors at greater risk of injury by necessitating that the erectors work hundreds of feet above ground. For example, guy wire towers are commonly constructed over 800 feet above the ground.

Accordingly, there is a need to provide communications towers which are structurally designed for field erection by assembling the uppermost approximate ten foot tower section, clamping this section with a clamping/jacking/hold down apparatus, raising that section approximately eleven feet, assembling and connecting the lower adjacent section to the upper section, lowering the two sections until they are resting on the reinforced concrete base, holding these sections from toppling while lowering the jacking assembly and re-clamping the assembled sections. Repetition of this procedure allows the complete tower erection from the ground level.

Accordingly, there is a need to provide communications towers which are less costly since they can be more efficiently shop fabricated and erected at ground level.

Accordingly, there is a need for communication tower erection which is safer for the erection personnel.

### SUMMARY OF THE INVENTION

It is an objective of the present invention to provide the structural design of two (2) types of communications towers a self standing tower and a guy cable supported tower which allows raising each tower from ground level with an upper section raised up and a lower section inserted below.

It is an objective of the present invention to provide the structural design of two (2) types of communications towers that are more cost effective to shop fabricate and less expensive to field assemble.

It is an another objective of the present invention to provide the design of erection apparatus that enables raising the towers from the ground level by fabricating the towers in such a manner that they can be erected by assembling and raising each section followed by assembling and raising the adjacent lower section until the tower is completely assembled.

It is also an objective of the present invention to provide the structural design of a hold down apparatus to prevent the toppling of the stand alone communications tower during the erection sequence.

It is an objective of the present invention to provide the structural design of a guy cable supported tower erection system which allows raising the guy tower from ground level by assembling and raising each section followed by, assembling and raising the adjacent lower section while simultaneously preventing the tower from toppling by use of the guy cable restraints.

It is another objective of the invention to provide such a method and apparatus that the tower can be economically assembled on site in a cost-effective manner while increasing personnel safety.

Further objects, features, and advantages of the present invention will become apparent from the detailed description of the invention which follows.

### BRIEF DESCRIPTION OF THE DRAWINGS

FIG. 1 is a elevation view of an example of a self standing communications tower according to the invention, which in this instance has a twenty foot (20′) equilateral triangular base and thirty sections at ten feet each tapering approximately 3 inches to a five foot (5′) equilateral triangular section at elevation three hundred feet (300′)

FIG. 2 is an plan view of a self standing communications tower according to the invention, which in this instance has a twenty foot (20′) equilateral triangular base and five foot (5′) at elevation three hundred feet (300′). It has vertical legs which can be eight inch (8″) diameter steel pipe with a wall thickness of 0.875″ for the first fifty feet (50′). 0 500″ wall the next eighty feet (80′), and 0.322″ wall the remaining one hundred seventy feet (170′) of 8″ steel pipe according to the invention. Where solid steel is desirable a seven inch (7″) diameter is sufficient as is shown in FIG. 2. It has 5/16″×5″×5″ hot rolled steel (HRS) angle horizontal and diagonal cross bracing.

FIG. 3 is a plan view showing how the FIG. 2 horizontal and diagonal cross bracing is attached to the vertical structural member by means of ¾″×2¼″ welded studs with a 5/16″×1″ slotted hole that receives a ¼″ HRS 1½″ to ¾″ tapered drive plate.

FIG. 4 is an elevation view of that FIG. 3 structural attachment of the cross bracing.

FIG. 5 is an elevation of a typical vertical splice joint/lifting/hold down member that serves as a structural vertical connection, a clamping member, a lifting member, and a hold down member of the self standing communications tower during erection.

FIG. 6 is a plan view of the shop fabricated “T” Slot Slide Plate Assembly that is bolted to the thirty six foot (36′) by thirty six loot (36′) by five foot (5″) deep concrete base that, according to the invention, allows the hydraulic Sliding Clamping/Jacking/Hold Down Apparatus to slide outward, thus compensating for the taper of the tower. The Sliding Clamping/Jacking/Hold Down Apparatus contained within the “T” Slot Slide Plate Assembly prevents the self standing communications tower from tipping over while the tower sections are being raised. The Sliding Hold Down Member, which serves to prevent the tower from toppling while the Sliding Clamping/Jacking/Hold Down Apparatus is undcamped and is being lowered for the next lift, also slides and is contained within the “T” Slot Sliding Plate Assembly.

FIG. 7 details the Sliding Clamping/Jacking/Hold Down Apparatus which slides in an out to compensate for the taper of the tower, clamps the tower and jacks the assembled tower sections of the tower upward approximately eleven feet, and in combination with the “T” Slot Sliding Plate Assembly prevents the tower from toppling during this sequence.

FIG. 8 is an elevation view of the erection of a self standing communications tower that shows two (2) of the three (3) Sliding Clamping/Jacking/Hold Down Apparatus and the Sliding Hold Down Member. The Sliding Hold Down Member serves to restrain the tower from tipping over while the Sliding Clamping/Jacking/Hold Down Apparatus is being lowered approximate ten (10) feet from its upper raised position to its adjacent lower lacking position.

FIG. 9 is an elevation view of the erection of a guy cable supported communications tower according to the invention that shows two (2) of the three (3) Sliding Jacking/Clamping Apparatus and one (1) of the three (3) typical concrete pillars. It illustrates typical structural strand guy cables with a factory connected galvanized closed end socket on the end connected to the guy tower and a galvanized Closed Bridge Socket with up to 72″ of adjustment on the other end. The Restraining Cut Bar prevents +the guy tower from toppling by restraining the Closed Bridge Socket which is connected to the Structural Strand Cable, which encircles the Concrete Cylclinder before being structurally connected to the Guy Tower.

FIG. 10 details the Concrete Pillars with its structural steel Embedded Plates that support the Concrete Cyclinder and Restraining Cut Bar.

FIG. 11 is a plan view of a guy cable supported communications tower which in this instance has a nominal five foot (5′) equilateral triangular frame from the base to the top. It has hot rolled steel solid hexagon bar legs with horizontal and diagonal “X” bracing at five foot (5′) on center vertically up the tower.

FIG. 12 details Sliding Clamping/Jacking Apparatus and the “T” Slot Sliding Plate Assembly necessary for the ground level erection.

### DETAILED DESCRIPTION OF THE INVENTION

The apparatus of the invention will be described in greater detail with reference to the accompanying Figures. In the Figures, like numbers represent like parts. These Figures represent only examples of apparatuses and erection of same within the scope of the invention, and do not limit nor restrict the scope of the invention. The description below is primarily with reference to use of the apparatus for communications towers such as microwave antennas, wireless telephone communications antennas, etc. However, as will be discussed in greater detail hereinafter, the apparatus, namely the communications towers with jacking & tipping restraint apparatus to enable entire erection from ground level, can also be used as a tower support for outdoor advertising or in applications where a need for high towers exists and with slight modification of the apparatus tailored to the intended use.

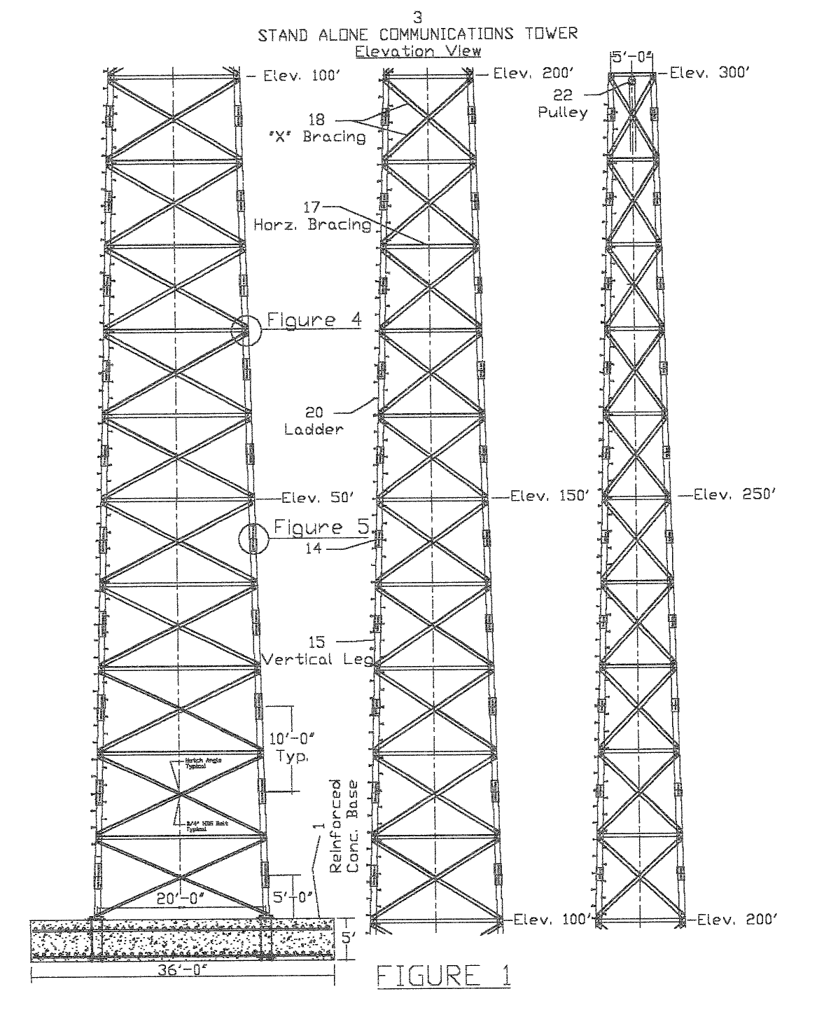

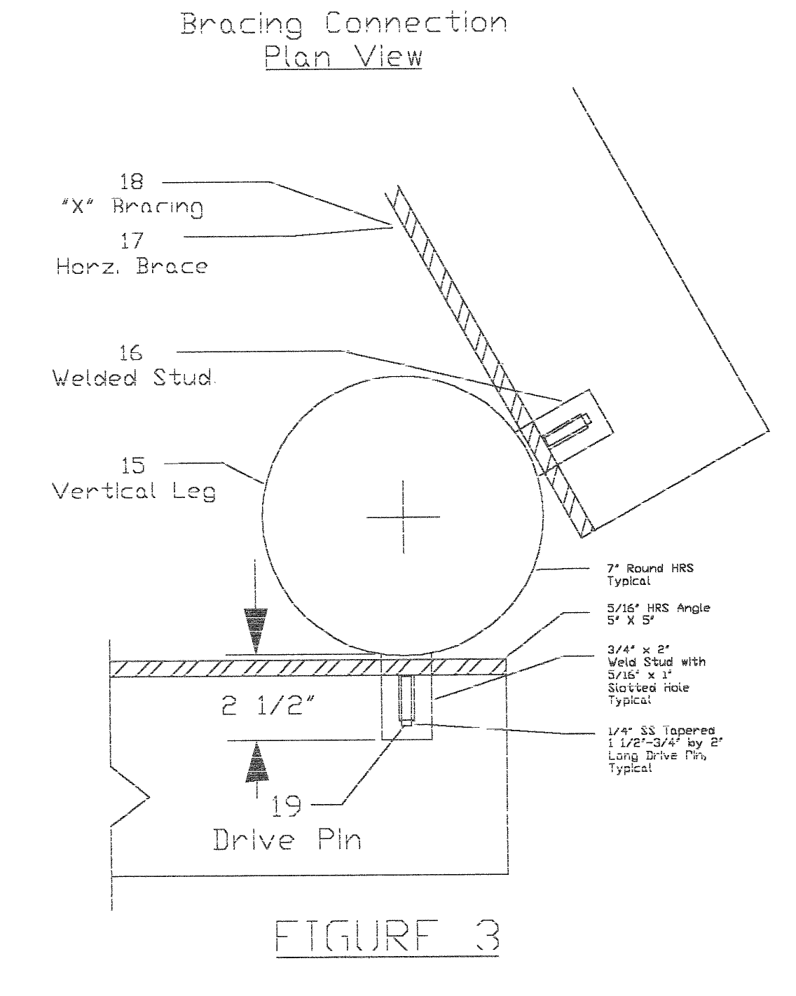

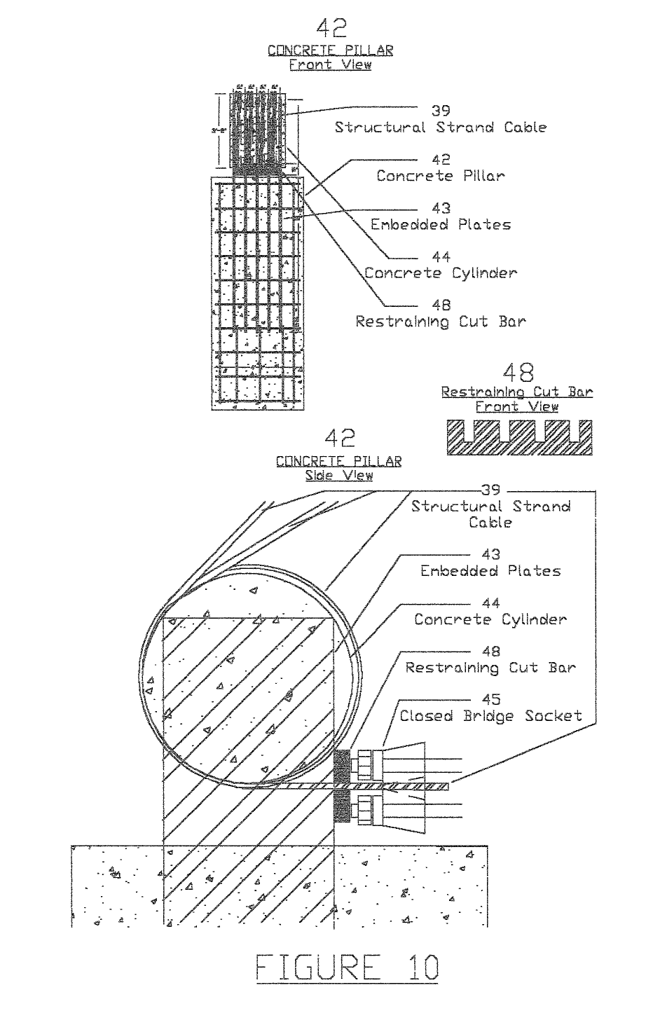

An example of the use of the apparatus of the invention is in the construction of communications towers wherein the jacking & tipping restraint apparatus enables the entire erection of the self standing or guy cable towers to be erected from ground level as is described with reference to FIGS. 1 through 12.

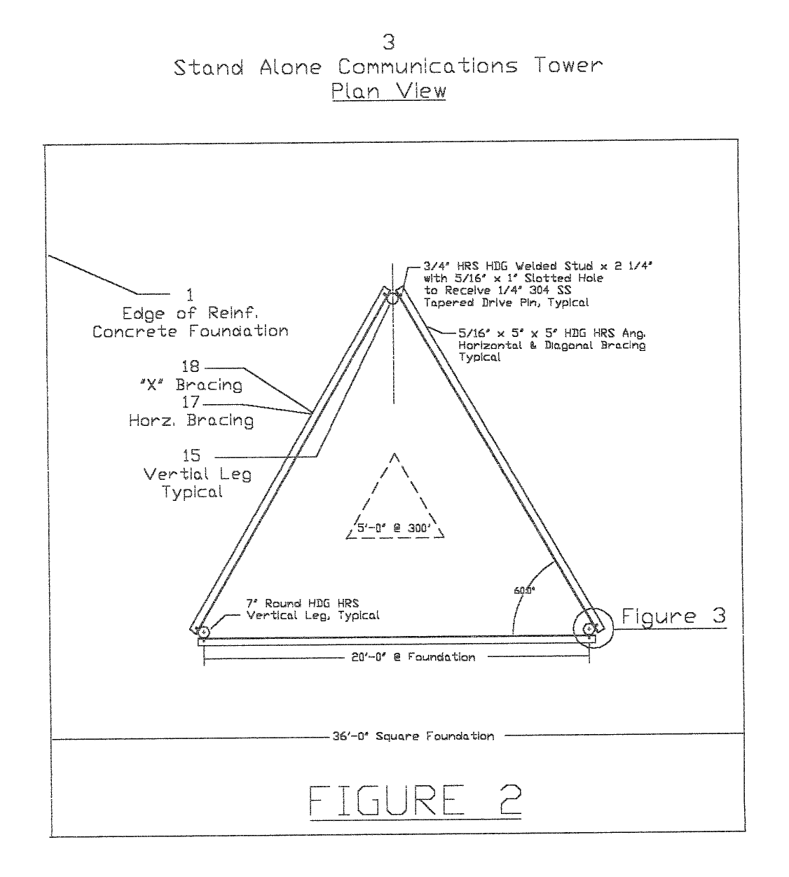

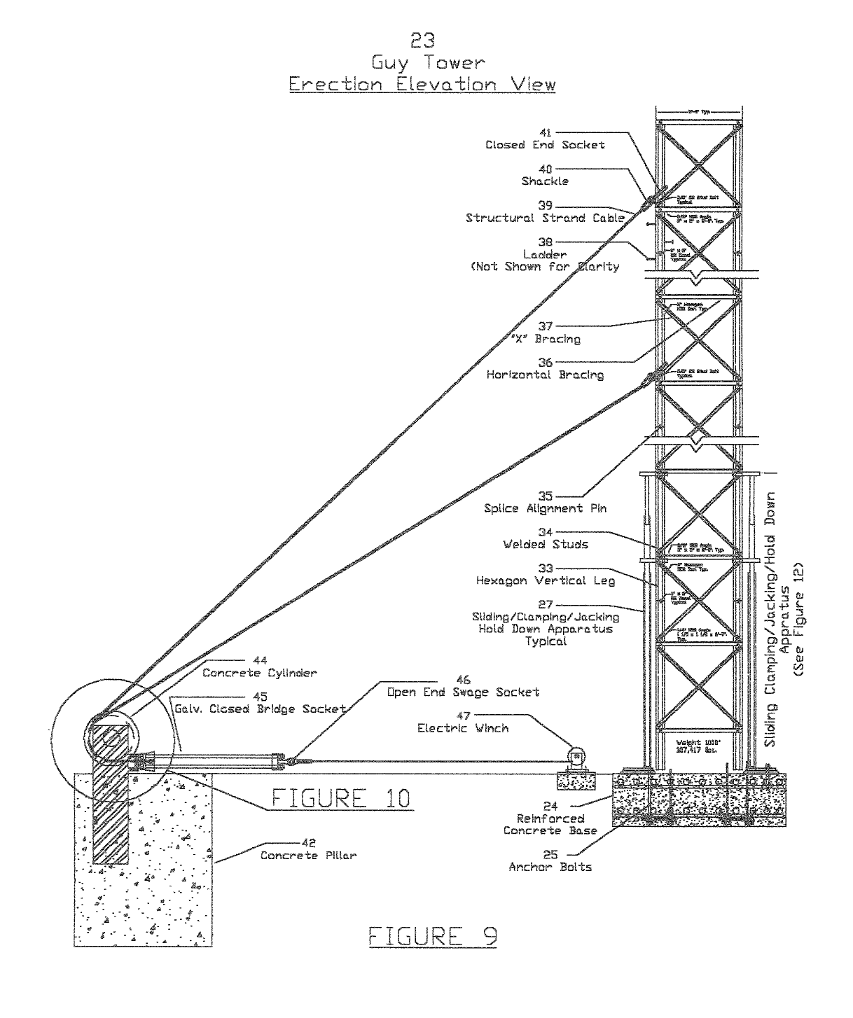

The communications tower as shown in FIGS. 1 and 2 show a stand alone tower (hereinafter tower) 300 feet high with a 20 foot equilateral triangular base and consists of thirty, ten foot, sections that tapers three inches every ten feet to five foot at the 300 foot elevation. FIGS. 9 through 12 show a guy cable supported communications tower (hereinafter guy tower) that is configured as a nominal five foot equilateral triangle and could be over 1000 feet high. Towers and guy towers are preferably configured as an equilateral triangle, but they can be assembled as a square or polygon. Greater or lesser dimensions in both height and base configuration are anticipated in this invention.

For a tower (see FIG. 1), first a reinforced concrete base 1 is formed with anchor bolts 2 precisely set to receive the three base plates that are welded to the stand alone communications tower 3 structure and the anchor bolts 2 that secure the three “T” Slot Slide Plate Assemblies 4. Next the concrete is poured of sufficient weight and strength to offset all tipping forces imposed on the stand alone communications tower.

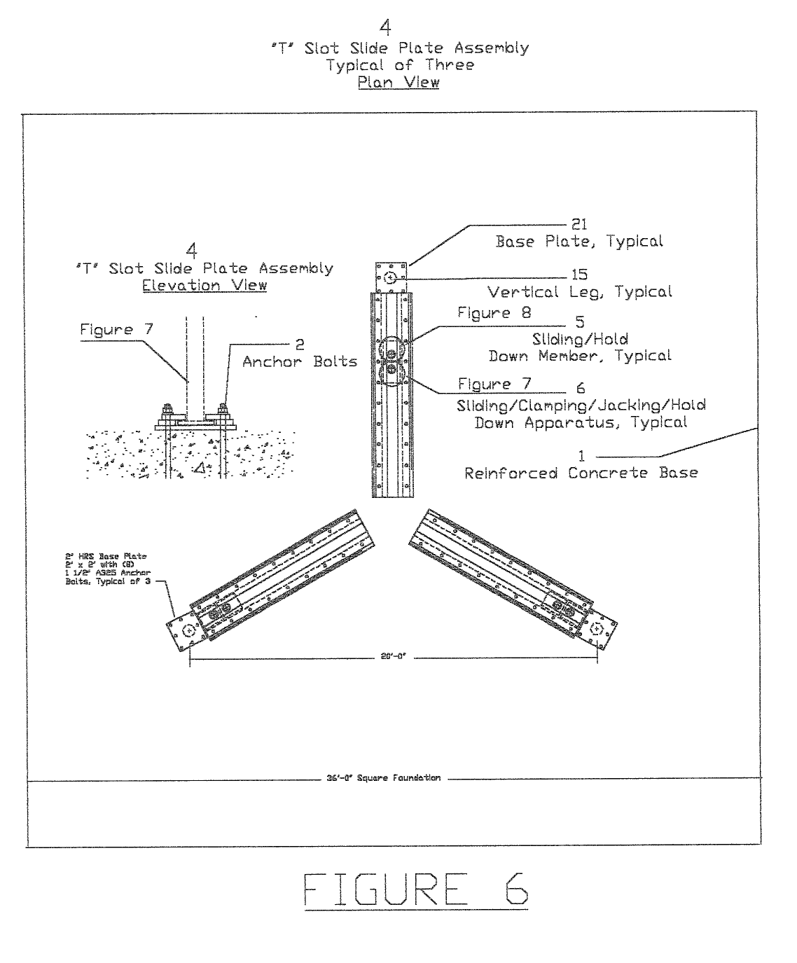

Next the three Sliding/Hold Down Members 5 and the three Sliding Clamping/Jacking/Hold Down Apparatus 6 (see FIGS. 6 & 8) are inserted into the T″ Slot Slide Plate Assemblies 4. Each Sliding Clamping/Jacking/Hold Down Apparatus 6 consists of the following:

a hot rolled steel (hereinafter HRS) sliding base plate 7 welded to

an eleven foot throw, 30 ton hydraulic cylinder 8 that is welded to

a cut HRS lifting plate 9 that is welded to

a 14 inch throw, 30 ton hydraulic cylinders 10 that is welded to

a cut HRS top clamping plate 11

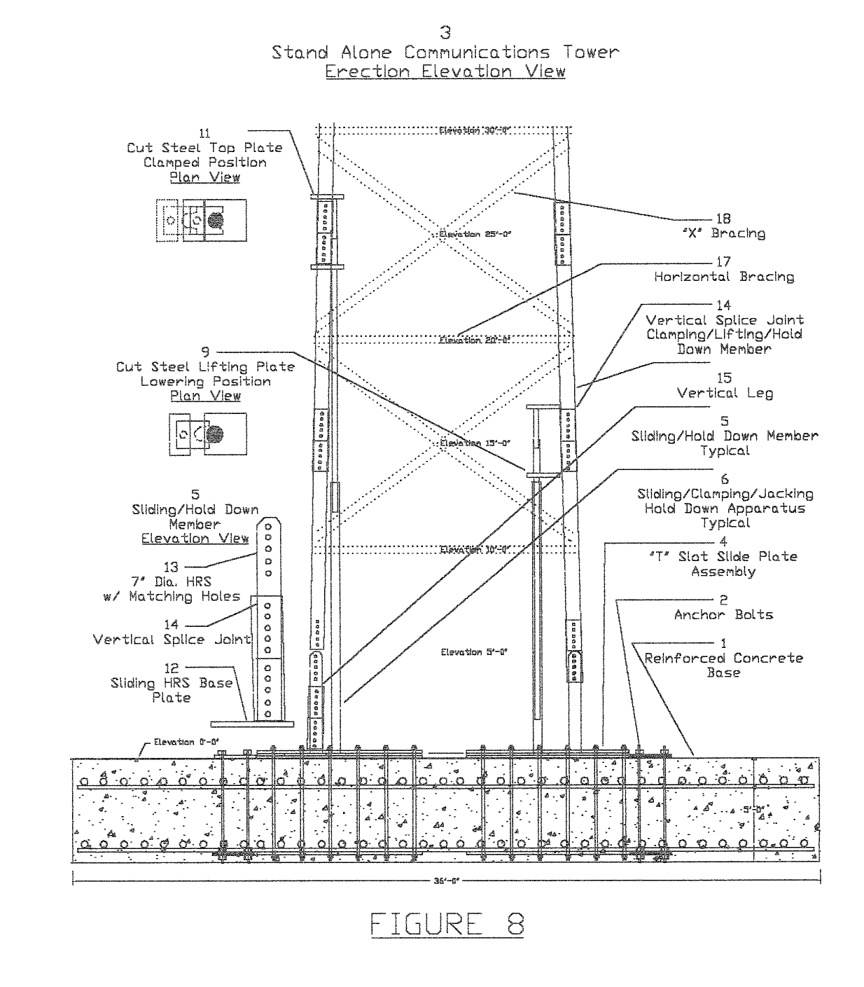

A Sliding Hold Down Member 5 (see FIG. 8), which holds the stand alone communications tower 3 while the Sliding Jacking/Clamping/Hold Down Apparatus 6 are unclamped and slid away from their raised position and are lowered approximately ten feet to the next clamping position and reattached for the next lift. The Sliding Hold Down Member 5 (see FIG. 8), is gusseted, welded, bolted, and mechanically held together and consists of.

a HRS base plate 12

a five foot vertical leg with matching holes 13

a Vertical Splice Joint 14

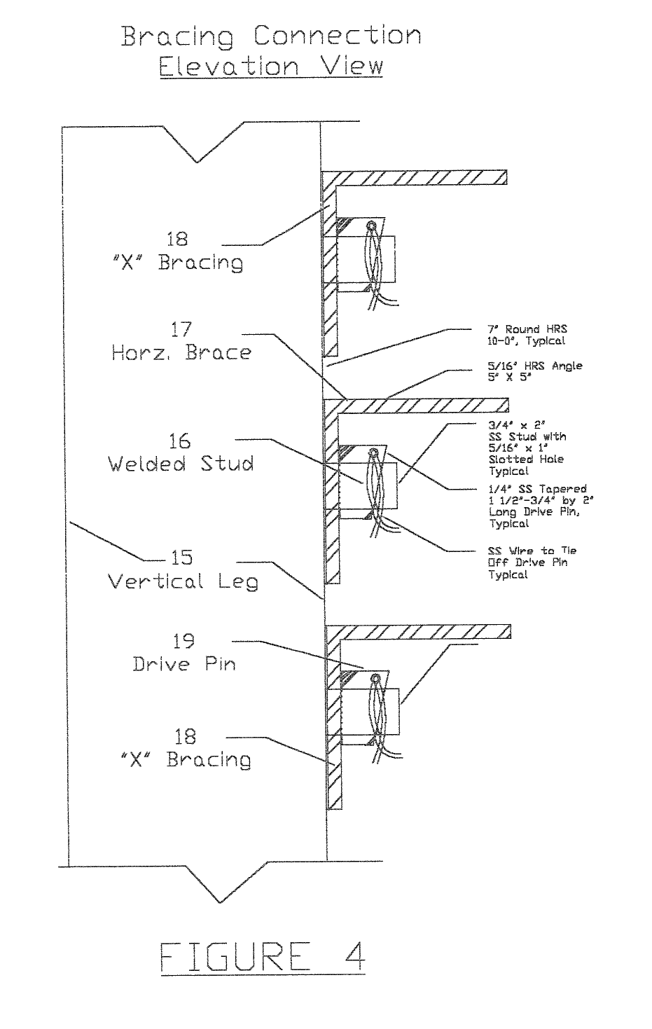

Now the erection of the stand alone communications tower 3 (see FIG. 1) is now ready to begin. The three uppermost vertical steel legs 15 are stood in place on the concrete base 1. Each vertical steel leg 15 has shop welded and/or bolted to its bottom a vertical splice joint clamping/lifting/hold down member 14. Each vertical steel leg 15 has six ¾″ diameter welded steel studs 16 with ¼″×1 ″ slotted holes. Shop fabricated horizontal HRS angles 17 (see FIG. 4) and HRS angle “X” bracing 18 are connected to the vertical steel legs 15 and secured in place by tapered drive pins 19 on a11 three sides of the stand alone communications tower. One of the three vertical legs has stud welded to it button head bolts at one foot on center to serve as a ladder 20.

The uppermost ten foot high section of the stand alone communications tower 3 is now ready to receive any antenna, signage, etc. that is desired to be mounted to that section. All required cabling is extended from its rotatable spools and attached to its respective antenna, lighting rod, lights, etc. This procedure is repeated at each section where desired.

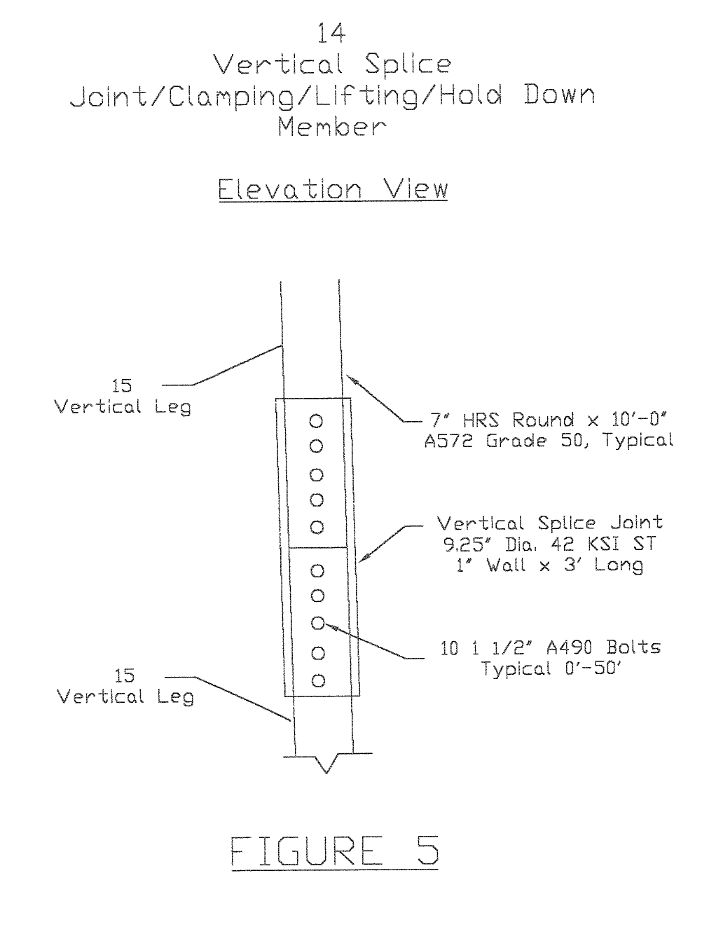

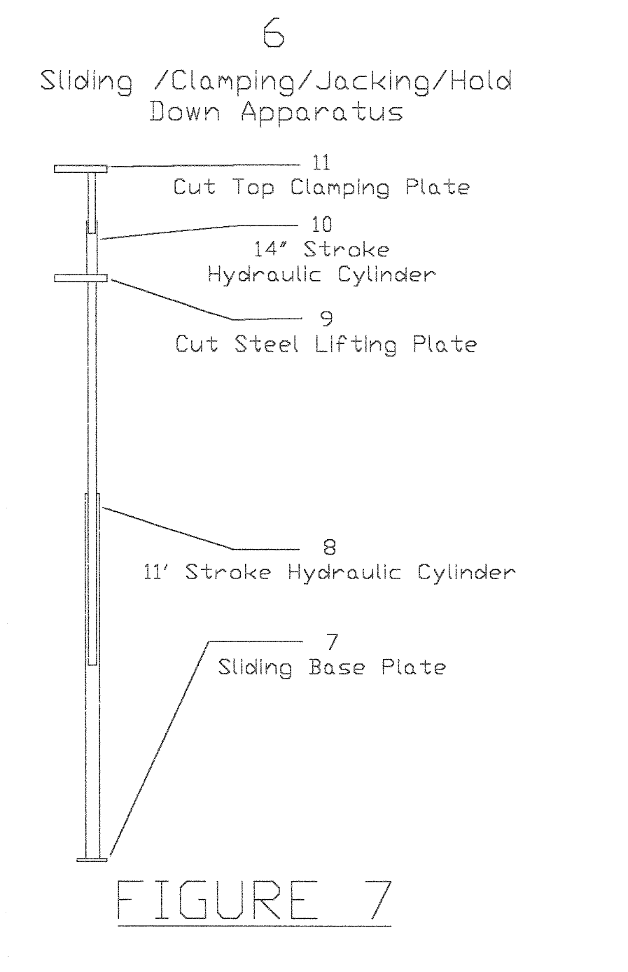

The three vertical legs 15 of the top section of the stand alone communications tower 3 is then hydraulically clamped at the top and bottom of the vertical splice joint clamping/lifting/hold down member 14 (see FIG. 5) by the Sliding Clamping/Jacking/Hold Down Apparatus 6 and raised approximately 11 feet. The next lower ten Soot section of the stand alone communications tower 3 is then assembled complete with vertical splice joint clamping/lifting/hold down members 14, shop fabricated horizontal HRS angle braces 17, shop fabricated notched and bolted HRS angle “x ” bracing 18, and ladder 20. The top two assembled stand alone communications tower 3 sections are then lowered until these sections are resting on top of the Sliding Hold Down Member 5 (see FIG. 8). The vertical splice joint 14 that is resting on the base plate 12 is then raised up the five foot vertical leg 13 to align with the matching holes and is temporarily bolted to support the partially assembled tower 3 to restrain the tower 3 from tipping while each Sliding Clamping/Jacking/Hold Down Apparatus 6 (see FIG. 7), is un-clamped, lowered, and re-clamped to the adjacent lower vertical splice joint clamping/lifting/hold down member 14.

This process is repeated until the last and lowest section of the stand alone communications tower 3 is ready for erection. Here the last three vertical steel legs 15, which are only five feet high and have shop welded to their bottom a HRS base plate 21 (see FIG. 6), are lowered over their anchor bolts 2 and secured into the permanent position.

It is the preferred intention of this invention that the installation of all lightening protection, warning lights, antennas, etc. be accomplished as the stand alone communications tower 3 erection progresses. Thus when the last section is in place all the antennas, tights, etc. are in place with their respective cabling attached at the top, secured to the stand alone communications tower 3 coming to the ground level, and extend to its wire spool ready for cutting and electrical hookup.

For access up the stand alone communications tower 3 one or more pulleys) 22 is (are) secured at the top center of the stand alone communications tower 3 with nylon rope leads to the ground level. Thus any desired access is accomplished by hooking the wire rope from a man riding UL approved winch, pulling that wire rope through the pulley with the nylon rope. Attaching the wire rope to a UL approve man riding bucket, and winching the man and any equipment up to the desired level of the stand alone communications tower 3 tower.

The Sliding Hold Down member 5, the Sliding Clamping/jacking/Hold Down Apparatus 6, and the “T” slot slide plate assemblies 4, are now removed and the fully assembled stand alone communications tower 3 is now ready for final connection of all cabling inspection, and use as a self standing communications tower 3.

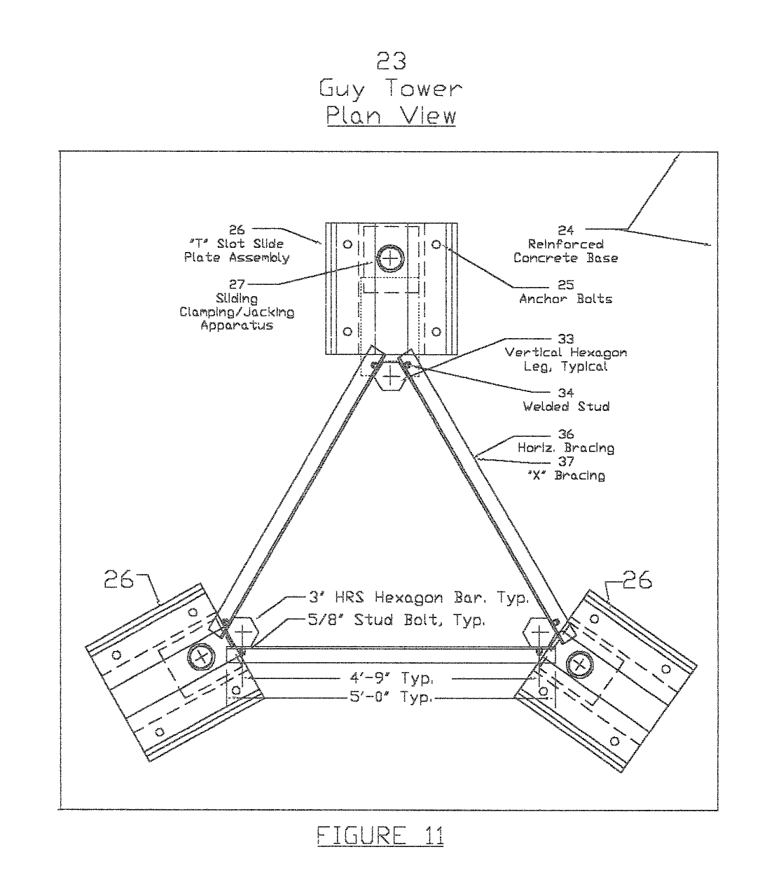

For a guy tower 23 (see FIG. 9), first a reinforced concrete base 24 is formed with anchor bolts 25 precisely set to receive the three base plates of the guy tower 23 tower, the anchor bolts 25 that secure the three “T” slot steel slide plate assemblies 26 (see FIG. 11) are precisely set prior to pouring a concrete base 24 which is then poured of sufficient depth to be below the frost line and strength to withstand all loads imposed by the guy tower 23.

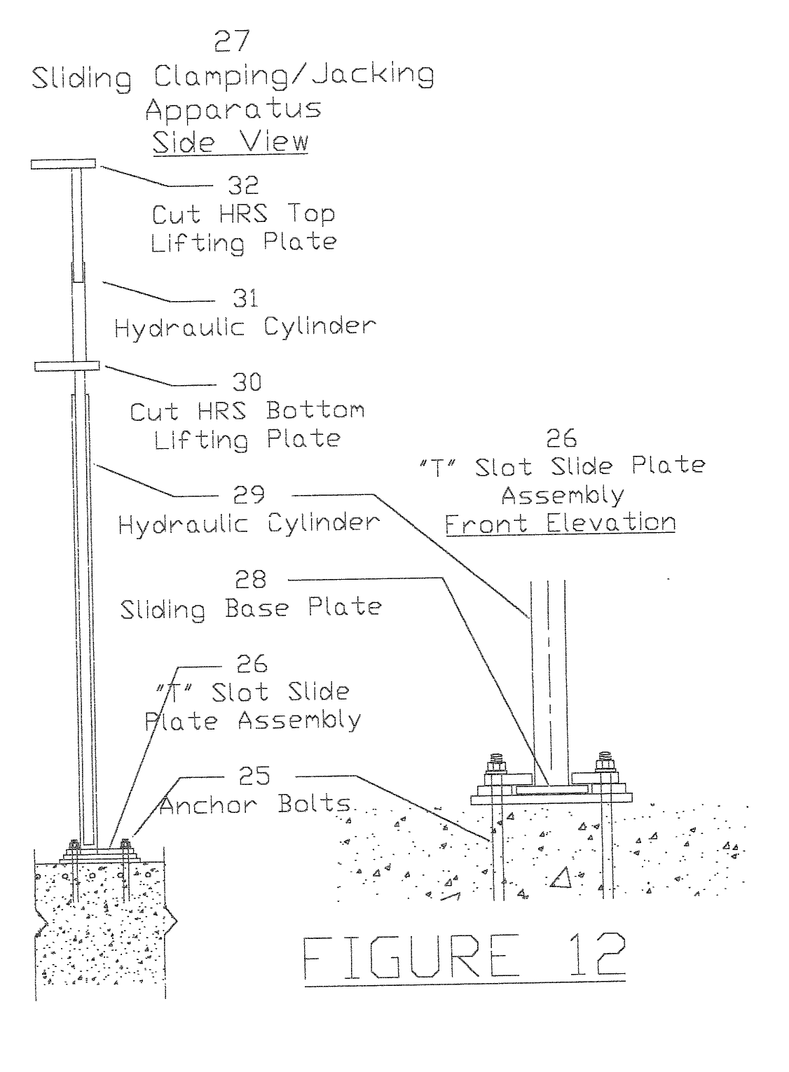

Three identical Sliding Clamping/Jacking Apparatus 27 (see FIG. 12) are inserted into the “T” slot slide plate assembly 26. Each Sliding Clamping/Jacking Apparatus 27 consists of the following:

a HRS sliding base plate 28 that is welded to

an eleven foot throw, 30 ton hydraulic cylinder 29 that is welded to

a cut HRS bottom lifting plate 30 that is welded to

a 14 inch throw, 30 ton upper hydraulic cylinder 31 that is welded to

a cut HRS top lifting plate 32

Now the erection of the guy tower 23 (see FIG. 9) is now ready to begin. The three uppermost vertical hexagon steel legs 33 are stood in place on the concrete base 24. Each vertical hexagon steel leg 33 in this invention is ten feet long and has shop welded studs 16 at five foot on centers on two sides of its hexagon shape. It also has a hole drilled in each end that receives a splice alignment pin 35. Each vertical hexagon steel leg 33 has at five foot on centers six ¾″ diameter shop welded steel studs 16 with ¼″×1″ slotted holes. Shop fabricated galvanized horizontal HRS angle bracing 36 and shop fabricated notched and bolted HRS angle “X” bracing 37, that is center notched and bolted, is placed over the welded studs 16 is connected to the vertical hexagon steel legs 33 and secured in place by tapered drive pins 19 on all three sides of the guy tower 23.

The uppermost section of the guy tower 23 is now ready to receive of all lightening protection, warning lights, antennas hoisting rigging, etc that is desired to be mounted to that section. Any cabling is extended from its rotatable spool and attached to its respective antenna, lights, etc. This procedure is repeated at each section where antenna, etc are desired.

Each of the three vertical hexagon steel legs 33 of the top section of the tower is then hydraulically clamped at the bottoms of horizontal braces 36 that are vertically five feet apart by the Sliding Clamping/Jacking Apparatus 27 and raised approximately 10 feet. The next lower ten toot section of the guy tower 23 is then assembled complete with shop fabricated horizontal HRS angle bracing 36 and shop fabricated notched and bolted HRS angle “X” bracing 37, vertical splice alignment pin 35, and ladder 38. The top two assembled guy tower 23 sections are then lowered until these sections are resting on the concrete base 24. The upper hydraulic lack 31 at each Vertical hexagon steel leg 33 is then lowered, which un-clamps the Sliding Clamping/Jacking Apparatus 27, which is then slid away from the vertical hexagon steel leg 33, and the Sliding Clamping/Jacking Apparatus 27 is lowered ten feet and re-clamped to the lower shop fabricated horizontal HRS angle bracing 17.

Tipping of the guy tower 23 is prevented by structural strand cabling 39 which is secured to the guy tower 23 by a shackle 40 that surrounds each vertical hexagon steel leg 33 atop the bolted HRS angle “X” bracing 37, and is attached to the structural strand cabling 39 via a factory attached closed end socket 41. The sizes of these parts are as structurally necessary for each guy tower 23 and they extend outward from each vertical hexagon steel leg 33 equilaterally in three directions to embedded steel reinforced concrete pillars 42.

Each of the three concrete pillars 42 has embedded hot dipped galvanized HRS plates 43 that are designed to structurally withstand the tipping forces imposed by the guy tower 23. These HRS plates 43 support a concrete cylinder 44 that has a minimum diameter of thirty times the diameter of the structural strand cabling 39. The structural strand cabling 39 is looped one 1½ or more times around the concrete cylinder 44 and terminates with a factory attached galvanized closed bridge socket 45 which by tightening or loosening allows up to 72″ of adjustment of tension on the structural strand cabling 39. The galvanized closed bridge socket 45 is connected via a wire rope open end swage socket 46 that extends to a wire rope winch 47 That is anchor bolted to a concrete base. Between the concrete cylinder 44 and the Galvanized closed bridge socket 45 is a HRS restraining cut bar 48 that has slots from the top of the HRS restraining cut bar 48 that allows the structural strand cabling 39 to penetrate the restraining cut bar 48 yet restrains the galvanized closed bridge socket 45 when pressed back against the restraining cut bar 48 by the tipping forces imposed by the guy tower 23. The restraining cut bar 48 is welded to the embedded hot dipped galvanized HRS plates 43 that are located on either side of the structural strand cables 39.

At the start of guy tower 23 erection, to prevent the toppling of the guy tower 23, three wire rope winches 47 pull the closed bridge socket 45 and structural strand cables 39 that are connected to the uppermost guy tower 23 section toward the concrete base until all three structural strand cabling 39 extending to the three concrete pillars 42 are in sufficient tension to keep the section from tipping, yet with enough slack to enable raising that section ten feet. Similarly additional guying is provided at lower locations as necessary to meet the structural requirements of the guy tower 23 complete with an individual wire rope winch 47 for each structural strand cable 39.

This process is repeated until the last and lowest section of the guy tower 23 is ready for attachment to the concrete base 24 Here the last three vertical hexagon steel legs 33, which have shop welded to their bottom a HRS base plate, are lowered over their anchor bolts 25 and secured into their permanent position.

For access up the guy tower 23, either by personnel or equipment, one or more pulley(s) is (are) secured at the top center of the guy tower 23 with nylon rope leads to the ground level. Thus any desired access is accomplished by hooking the wire rope from a man riding UL approved winch, pulling that wire rope through the pulley with the nylon rope, attaching the wire rope to a UL approve man riding bucket, and winching the man and any equipment up to the desired level of the guy tower 23.

The final tension on the structural strand cables 39 is adjusted at the closed bridge sockets 45. The Sliding Clamping/Jacking Apparatus 27 and the wire rope winches 47 are removed and the fully assembled guy tower 23 is now ready for final connection of all cabling, inspection, and use as a guy wire communications tower.

All steel shall be hot dipped galvanized after shop fabrication. All welding shall be in conformance with AWS D 1-92 standards with E70XX electrodes. Any field welds shall be touched up with cold galvanizing. Warning lights shall be in conformance with FAA regulations. Lightening protection shall always be provided in accordance with National Electrical Code 250-84. All design, fabrication, and construction shall be in conformance with EIA/TIA-222-E for each jurisdiction and all Federal, State. and Local regulations.

The stand alone communications tower 3 and the guy tower 23 that comprise the present invention may have any desired shape, such as a square or polygon, however, due to the advantageous fabrication techniques developed by the present inventors, the stand alone communications tower 3 and guy tower 23 are preferably fabricated as an equilateral triangle. The materials, preferably hot rolled steel, used to construct stand alone communications tower 3 and guy tower 23 may have any desired thickness and/or diameter as required for structural purposes. All required gusset plates shall be welded in place where necessary.

The stand alone communications tower 3 and guy tower 23 may be fabricated of any desired materials, for example, of steel, other metals, composites, and/or plastics that meet the requirements of EIA/TIA-222-E in each jurisdiction and all Federal, State, and Local regulations.

It is intended that the detailed description of preferred embodiments be considered as exemplary only. Other embodiments of the invention will be apparent to those skilled in the art from consideration of the specification and practice of the invention disclosed herein.

What is claimed is:

1. An apparatus comprising a stand alone communications tower structurally designed to permit repetitive jacking of the partially assembled tower upwards and assembling the adjacent lower section until the tower is completely erected, thus allowing erection personnel to complete the entire erection at nominal around level

2. An apparatus comprising a guy cable supported communications tower structurally designed to permit repetitive jacking of the partially assembled guy supported communication tower upwards and assembling the adjacent lower section until the guy tower is completely erected, thus allowing erection personnel to complete the entire erection at nominal ground level

3. An apparatus that simultaneously both jacks upward and restrains from toppling a stand alone communications tower during its entire erection process. The tower is structurally designed to permit repetitive sacking of the partially assembled tower upwards and assembling the adjacent lower section until the tower is completely erected, thus allowing erection personnel to complete the entire erection at nominal ground level.

4. An apparatus that simultaneously both jacks upward and restrains from toppling a guy cable supported communications tower during its entire erection process. The guy cable supported communications tower is structurally designed to permit repetitive jacking sections of the partially assembled guy tower upwards and assembling the adjacent lower section until the guy supported communication tower is completely erected thus allowing erection personnel to complete the entire erection at nominal ground level.

5. An apparatus that restrains the stand alone communications tower from tipping over during the erection process during the period that the jacking apparatus is disengaged from raised position and is being lowered and re-engaged at the lower position.

6. An apparatus that restrains the guy cable supported communications tower from tipping over during the erection process by the jacking apparatus.

7. An apparatus that allows more efficient fabrication and erection of stand alone communications towers.

8. An apparatus that allows more efficient fabrication and erection of guy cable supported communications towers.

9. An apparatus that allows for the installation at the ground level of antenna, cabling from the ground level to the antenna signage etc on stand alone communications towers.

10. An apparatus that allows for the installation at the ground level of antenna, cabling from the ground level to the antenna, signage, etc. on guy cable supported communications towers.

11. An apparatus that provides safer working conditions to the erection personnel during the erection of stand atone communications towers

12. An apparatus that provides safer working conditions to the erection personnel during the erection of guy cable supported communications towers

13. An apparatus as claimed herein for the erection of any tower where erection of that tower at the ground level by jacking up the partially assembled components is beneficial
